(19) United States
(12) Patent Application Publication
(10) Pub. No.: US 2008/0190008 A1
(43) Pub. Date: Aug. 14, 2008

(54) Scented trail apparatus

(76) Inventor: Trevor M. Aslin, Texarkana, TX (US)

Correspondence Address: John M. Harrison, 2139 E. Bert Kouns, Shreveport, LA, 71105, US

(21) Appl. No.: 12/012,041

(22) Filed: Jan. 31, 2008

Related U.S. Application Data
(60) Provisional application No. 60/900,705, filed on Feb. 12, 2007.

(51) Int. Cl. A01M 31/00

(52) U.S. Cl. 43/1

(57) ABSTRACT

A scented trail apparatus for applying a scent trail across selected terrain and luring animals along the scent trail to a blind or observation area, which apparatus includes a scent canister secured at one end of the trail and containing an animal scent lure; a reel apparatus located at the other end of the trail; a scent carrier for insertion in the scent canister and receiving a quantity of the animal lure scent in the scent canister; and a line connecting the reel and the scent carrier. A cap typically encloses the scent carrier and a segment of the line inside the scent canister and the scent carrier is caused to traverse the trail by operation of the reel to apply a residue of animal lure scent along the scent trail. A line depressor may be used to depress the line and the scent carrier on or close to the ground while the scent carrier and line are manually pulled from the reel to the scent canister.

### CROSS-REFERENCE TO RELATED APPLICATIONS

This application claims the benefit of and incorporates by reference in its entirety prior filed copending Provisional Application Ser. No. 60/900,705, Filed Feb. 12, 2007.

### SUMMARY OF THE INVENTION

Various scent-dispensing devices have been utilized by hunters and animal observers to dispense animal scent lure in order to obtain a sight advantage in luring animals to a stand, blind or observation point. The scented trail apparatus of this invention includes a scent canister typically containing a quantity of animal lure scent and secured to a tree, bush, rock or other object for containing a scent carrier, which is typically constructed of one or more liquid absorbent strips attached to a scent strip mount. A cap may be used to removably enclose the animal lure scent and the scent carrier inside the scent canister in a friction-fit and a reel is typically disposed in spaced-apart relationship with respect to the scent canister at or near a stand or blind and at the opposite end of the trail to which the animal scent lure will be applied. The reel may be manually-operated or automatic and may likewise be attached to a tree, bush, rock, hunting stand or blind, or other object. A line, which is typically characterized by a monofilament fishing line, extends from the spool of the reel along the trail for attachment to the scent strip mount element of the scent carrier. Accordingly, when the scent carrier is removably placed in the scent canister or removably closed inside the scent canister by a cap, operation of the reel applies tension to the line and if the cap is in place, the line tension causes the cap to be removed from the end of the scent canister and allows exit of the scent carrier from the scent canister. Continued operation of the reel causes the scent carrier to traverse the trail and leave a residue of animal lure scent thereon, between the scent canister and the reel. A line depressor, typically having a fork at one end, can be used to manually depress the line rearwardly of the scent carrier to direct the scent carrier into a desired proximity with respect to the ground along the trail as the line is initially extended from the reel and the scent carrier is carried to the scent canister.

### BRIEF DESCRIPTION OF THE DRAWINGS

The invention will be better understood by reference to the accompanying drawings, wherein:

FIG. 1 is a perspective view of a typical embodiment of the scented trail apparatus of this invention, including a removable scent canister cap in place on a scent canister and a reel fitted with a monofilament fishing line, with a segment of the line secured between the cap and the scent canister;

FIG. 2 is a perspective view of the scent canister illustrated in FIG. 1, more particularly illustrating the cap and the scent canister in open configuration and a scent carrier removably positioned in the scent canister;

FIG. 3 is a perspective view of the scent canister illustrated in FIG. 2, with the cap in open configuration and the scent carrier removed from the scent canister for traversal of a trail; and

FIG. 4 is a perspective view of the embodiment of the scented trail apparatus illustrated in FIG. 1, illustrating a typical line depressor for depressing the line forwardly of the scent carrier illustrated in FIG. 3, as well as the spaced-apart positioning of the reel from the scent carrier and scent canister along a trail.

### DESCRIPTION OF THE PREFERRED EMBODIMENTS

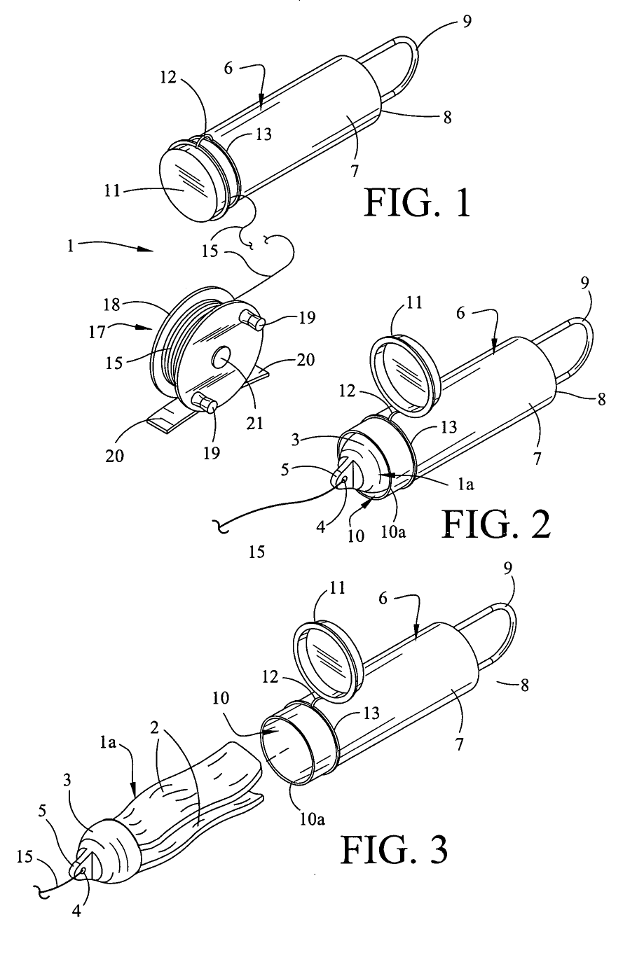

Referring initially to FIGS. 1-3 of the drawings, an embodiment of the scented trail apparatus of this invention is generally illustrated by reference numeral 1. In this embodiment the scented trail apparatus 1 is characterized by a scent canister 6, typically having a generally cylindrical canister housing 7 defining a canister housing interior 10 and having a housing mount end 8, with a canister retainer 9 extending therefrom. The opposite end of the scent canister 6 is open at an interior lip 10a (FIGS. 2 and 3) to removably receive a cap 11, typically fitted with a cap tether 12 for retaining the cap 11 on the open end of the canister housing 7 of the scent canister 6. The cap 11 is typically designed to fit on the interior lip 10a of the canister housing 7 in a friction-fit, as hereinafter further described. A cap band 13 may be typically be used to attach the cap tether 12 to the canister housing 7 of the scent canister 6.

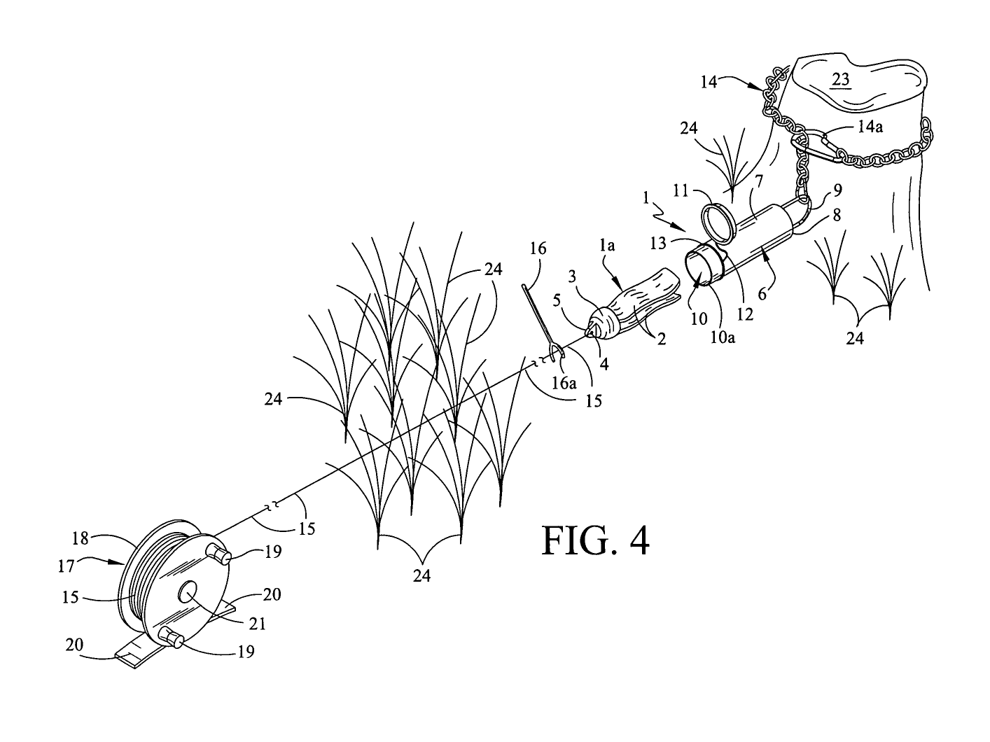

As illustrated in FIGS. 1 and 4 of the drawings the reel 17 has a rotatable spool 18 fitted with one or more spool grips 19 and journalled for rotation on a frame 20 by means of a shaft or spindle 21. A line 15, which may be of any size and character, but is typically characterized by monofilament fishing line, is wound on the spool 18, as illustrated in FIG. 4 of the drawings. The opposite end of the line 15 is typically secured to a mount eye 4, provided in an eye bracket 5 attached to a scent strip mount 3 of a scent carrier 1a. Referring again to FIGS. 2 and 3, it will be appreciated that the scent carrier 1a, including a pair of typically flexible, liquid-absorbent scent strips 2, attached to the scent strip mount 3, can be inserted in the open end of the canister housing 7 of the scent canister 6. In one embodiment an animal lure scent (not illustrated) can be poured or otherwise placed in the canister housing interior 10 of the canister housing 7, to coat or saturate the scent strips 2 with an animal scent lure of choice. Alternatively, the scent strips 2 can be coated or saturated with an animal scent lure and the scent strips 2 then placed in the canister housing interior 10. Under circumstances where the scent carrier 1a is inserted in the canister housing 7 as illustrated in FIG. 2, the typically plastic cap 11 can be closed over the interior lip 10a of the canister housing 7, with a portion or segment of the line 15 depressed between the cap 11 and the canister housing 7, as illustrated in FIG. 1.

Referring now to FIG. 4 of the drawings, under circumstances where it is desired to use the scented trail apparatus 1 to create a scented trail through brush 24, typically between a tree 23 and the reel 17, the latter of which is spaced-apart from the scent canister 6, the scent canister 6 is initially secured or tethered to the tree 23, typically using a retainer strap, rope or chain 14 and clip 14a. The retainer chain 14 may be typically secured to the canister retainer 9 at the housing mount end 8 of the canister housing 7. The scent carrier 1a is attached to the line 15 and wound to the reel 17 and a quantity of the animal scent lure (not illustrated) is either placed inside the canister housing 7 of the scent canister 6 or applied directly to the scent strips 2. The reel 17 is then attached to brush 24 or to a tree or stake at a blind or observation area (not illustrated) and the scent carrier 1a is grasped and the line 15 manually carried and unwound from the spool 18 along a predetermined trail, until the scent carrier 1a is located at the tree 23, where it is inserted in the scent canister 6. The cap 11 is then closed over a segment of the line 15 near the eye bracket 5 of the scent strip mount 3, as illustrated in FIGS. 1 and 2 of the drawings. The reel 17 is then activated, either manually by grasping the spool grip or grips 19 and rotating the spool 18, or automatically, using an electric reel of suitable design, according to the knowledge of those skilled in the art. Rotation of the spool 18 applies tension to the line 15 and causes the cap 11 to be removed from the friction-fit on the interior lip 10a of the canister housing 7. Additional tension applied to the line 15 by continued rotation of the spool 18 causes the scent carrier 1a to exit the now-open canister housing interior 10 as illustrated in FIGS. 3 and 4 of the drawings, and traverse the brush 24 along the terrain of the predetermined trail between the scent canister 6 and the reel 17.

During the initial transportation by hand of the scent carrier 1a through the brush 24 from the reel 17 to the scent canister 6, a line depressor 16, having a depressor fork 16a, may be typically manually applied to the line 15 at the depressor fork 16a, to force the line 15 downwardly against or near the ground or terrain as the scent carrier 1a is carried through the brush 24. Reverse movement of the scent carrier 1a along the trail by operation of the reel 17 then operates to leave a residue of animal lure scent from the scent strips 2 along the trail between the scent canister 6 and the reel 17. When the scent carrier 1a reaches the reel 17 the desired scent trail has been established between the scent canister 6 and the reel 17 and the scent carrier 1a and reel 17 are put aside, while the scent canister 6 typically remains in position at the tree 23.

It will be appreciated by those skilled in the art that use of the line depressor 16 is optional for adjusting the height of the line 15 from the ground and depending upon the nature of the terrain and the plant, grass and tree growth or rocky ground between the scent canister 6 and the reel 17, the line dispenser 16 may not be needed. However, under circumstances where fairly thick grass or brush 24 is located between the scent canister 6 and the reel 17, the line depressor 16 may be utilized to manually engage the depressor forks 16a with the line 15 rearwardly of the scent carrier 1a as the scent carrier 1a is carried along the terrain to the scent canister 6, into a desired position between the ground and the grass or brush 24, to leave the residue of animal scent lure at a selected level along the scent trail. It is understood that a selected length of line 15 can be located in the scent canister 6 and saturated or coated with scent in lieu of the scent carrier 1a. This segment or length of the line 15 remains in place along the trail after deployment.

It will be further appreciated by those skilled in the art that the scent canister 6 may be of any shape, size and design which is characterized by a container having a closed or sealed canister housing suitable for application of a typically liquid animal scent lure for enclosing animal scent and a scent carrier of selected design. Alternatively, saturation or coating of the absorbent scent strips on the scent carrier or on the segment of line 15 can be effected for leaving the desired scent residue along the trail. Furthermore, any number of scent strips 2 can be utilized with the scent strip mount 3 on the scent carrier 1a and the scent strip or strips 2 are typically constructed of flexible felt, sponge or an alternative liquid-absorbent material, to facilitate easy insertion in and removal from the canister housing interior 10 of the canister housing 7. It will be further appreciated that the canister housing 6 and the reel 17 can be attached or tethered to substantially any spaced-apart objects, such as stumps, rocks or stakes, as well as a tree 23 or even some brush 24, to relatively immobilize, tether or secure the reel 17 and scent canister 6 in place and facilitate placement of the scent carrier 1a or the scent-impregnated segment of the line 15 in the scent canister 6 and later retrieval of the scent canister 1a or segment of the line 15 from the scent canister 6, by tension in the line 15 responsive to operation of the reel 17. Moreover, the scent canister 6 may be designed such that the scent strip or strips 2 or the scented segment of the line 15 are encapsulated inside. This design allows the scent strip or strips 2 or the segment of the line 15 to be pulled through the encapsulated seal and deployed as described above. This allows use of a non-capped canister 6 with the animal scent lure and scent carrier 1a or the scented segment of the line 15 placed in the canister housing interior 10 without using the cap 11.

It will also be appreciated by those skilled in the art that the reel 17 may be of any desired design, including the design illustrated in the drawings, or a fishing reel of any character, as well as a more simple device, such as a stick or board for receiving the monofilament line 15 wound thereon. Moreover, when a reel 17 of selected design is utilized, it may be manual and provided with one or both of the indicated reel spool grips 19 as illustrated in FIGS. 1 and 4, or it may be automated by an electric motor (not illustrated), according to the knowledge of those skilled in the art. When automated, the reel 17 may be secured to the stand or blind (not illustrated) at one end of the trail and activated, and the user may first carry the scent carrier 1a to the scent canister 6 and optionally utilize the line depressor 16 by placing the depressor forks 16a on the line 15 rearwardly of the scent carrier 1a, to effect the desired later application of animal scent residue on, or at a selected height above, the ground and through the brush 24 by operation of the reel 17.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A scented trail apparatus for scent marking a trail comprising a scent canister containing an animal lure scent positioned at one end of the trail; a scent carrier disposed for removable insertion in said scent canister, said scent carrier contacting the animal lure scent; a reel apparatus positioned at the other end of the trail; and a line having one end connected to said reel apparatus and the opposite end of said line attached to said scent carrier, wherein said scent carrier is pulled from said scent canister along the trail and said scent carrier marks the trail with the animal lure scent responsive to operation of said reel apparatus.

2. The scented trail apparatus of claim 1 comprising a cap for removably engaging said scent canister and removably enclosing said scent carrier and a portion of said line inside said scent canister, wherein said cap is displaced from said scent canister by tension in said line responsive to said operation of said reel apparatus.

3. The scented trail apparatus of claim 2 comprising a cap tether connecting said cap to said scent canister.

4. The scented trail apparatus of claim 1 comprising a line depressor for engaging said line and guiding said scent carrier along the trail.

5. The scented trail apparatus of claim 1 comprising a cap for removably engaging said scent canister and removably enclosing said scent carrier and a portion of said line inside said scent canister, wherein said cap is displaced from said scent canister by tension in said line responsive to said operation of said reel apparatus, and further comprising a line depressor for engaging said line and guiding said scent carrier along the trail.

6. The scented trail apparatus of claim 5 comprising a cap tether connecting said cap to said scent canister.

7. The scented trail apparatus of claim 1 wherein said scent carrier comprises a scent strip mount attached to said opposite end of said line and at least one scent carrier strip carried by said scent strip mount for receiving a portion of the animal lure scent in said scent canister and leaving a residue of the animal lure scent along the trail.

8. The scented trail apparatus of claim 7 comprising a cap for removably engaging said scent canister and removably enclosing said scent strip mount, said scent carrier strip and a portion of said line inside said scent canister, wherein said cap is displaced from said scent canister by tension in said line responsive to said operation of said reel apparatus.

9. The scented trail apparatus of claim 8 comprising a cap tether connecting said cap to said scent canister.

10. The scented trail apparatus of claim 7 comprising a line depressor for engaging said line and guiding said scent carrier along the trail.

11. The scented trail apparatus of claim 7 comprising:
(a) a cap for removably engaging said scent canister and enclosing said scent strip mount, said scent carrier strip and a portion of said line inside said scent canister, wherein said cap is displaced from said scent canister by tension in said line responsive to said operation of said reel apparatus; and
(b) a line depressor for engaging said line and guiding said line along the trail.

12. The scented trail apparatus of claim 7 wherein said at least one scent carrier strip comprises a pair of flexible, absorbent strips carried by said scent strip mount.

13. The scented trail apparatus of claim 12 comprising:
(a) a cap for removably engaging said scent canister and removably enclosing said scent strip mount, said scent carrier strip and a portion of said line inside said scent canister, wherein said cap is displaced from said scent canister by tension in said portion of said line responsive to said operation of said reel apparatus; and
(b) a cap tether connecting said cap to said scent canister.

14. The scented trail apparatus of claim 13 comprising a line depressor for engaging said line and guiding said scent strip mount and said felt strips along the trail.

15. An apparatus for leaving an animal lure scent in a selected scent path along a terrain, said apparatus comprising a scent canister disposed in a selected tethered position; a scent carrier having an animal lure scent and normally removably disposed in said scent canister; a line having one end attached to said scent carrier and the opposite end of said line projecting from said scent canister and said scent carrier; a cap normally removably closing on said scent canister over said line and removably enclosing said scent carrier inside said scent canister; and a reel apparatus spaced-apart from said canister and receiving the opposite end of said line, wherein said cap is displaced from said scent canister by said line and said scent carrier is pulled from said scent canister along the scent path responsive to operation of said reel.

16. The apparatus of claim 15 comprising a line depressor for engaging said line and guiding said scent carrier along the scent path.

17. The apparatus of claim 15 wherein said scent carrier comprises a scent strip mount attached to said one end of said line and at least one absorbent strip carried by said scent strip mount for absorbing a quantity of the animal lure scent and leaving residual animal lure scent along the scent path.

18. The apparatus of claim 15 comprising a cap tether connecting said cap to said scent canister.

19. The apparatus of claim 17 wherein said at least one absorbent strip comprises a pair of flexible, absorbent strips carried by said scent strip mount and comprising a line depressor for engaging said line and guiding said scent strip mount and said flexible, absorbent strips along the scent path.

20. An apparatus for leaving an animal lure scent trail over selected terrain, said apparatus comprising a scent canister secured in a selected position and containing animal lure scent; a scent carrier having at least one flexible, absorbent member normally disposed in said scent canister for absorbing a quantity of the animal lure scent; a line having one end carried by said scent carrier and the opposite end of said line projecting from said scent canister; a cap normally removably closing on said scent canister over said line and removably enclosing said scent carrier and said flexible, absorbent member inside said scent canister; a reel spaced-apart from said scent canister and receiving the opposite end of said line wherein said scent carrier and said flexible, absorbent member are pulled from said scent canister along the terrain when said cap is displaced from said scent canister responsive to operation of said reel and tension in said line; and a line depressor for engaging said line and guiding said scent carrier along the terrain.
